(19) United States
(12) Patent Application Publication
(10) Pub. No.: US 2009/0222397 A1
(43) Pub. Date: Sep. 3, 2009

(54) Beta node indexing in a rule engine

(76) Inventors: Mark Proctor, Chiswick (GB); Edson Tirelli, Sao Paulo (BR)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/074,215

(22) Filed: Feb. 29, 2008

(51) Int. Cl. G06N 5/02

(52) U.S. Cl. 706/48; 706/47

(57) ABSTRACT

Some embodiments of beta node indexing in an exemplary rule engine have been presented. In one embodiment, a rule engine creates a network based on a set of rules. The network includes at least one multiple-input node, such as a beta node having two inputs. The beta node further includes a memory associated with each input. The rule engine may generate a single index for at least one of the memories of the beta node based on a set of predetermined attributes of elements within the memory. Examples of the elements include tuples and data objects. The index includes a set of composite keys, each having a value of each of the attributes.

### TECHNICAL FIELD

Embodiments of the present invention relate to artificial intelligence, and more specifically to rule engines.

### BACKGROUND

The development and application of rule engines is one branch of Artificial Intelligence (A.I.), which is a very broad research area that focuses on “making computers think like people.” Broadly speaking, a rule engine processes information by applying rules to data objects (also known as facts). A rule is a logical construct for describing the operations, definitions, conditions, and/or constraints that apply to some predetermined data to achieve a goal. Various types of rule engines have been developed to evaluate and process rules. Conventionally, a rule engine implements a network to process rules and data objects, such as the example shown in FIG. 1. A network may include many different types of nodes, including, for example, object-type nodes, alpha nodes, left-input-adapter nodes, eval nodes, join nodes, not nodes, and terminal nodes, etc. Referring to FIG. 1, the network 100 includes two object-type nodes 111 and 121, two alpha nodes 113 and 123, a left-input-adapter node 115, a join node 130, and a terminal node 140.

Typically, data objects enter a network at the root node, from which they are propagated to any matching object-type nodes. From a object-type node, a data object is propagated to either an alpha node (if there is a literal constraint), a left-input-adapter node (if the data object is the left most object type for the rule), or a beta node (such as a join node). For example, referring to FIG. 1, a data object 101 is propagated to a matching object-type node 111. From the ObjectType Node 111, the data object 101 is propagated to an alpha node 113, and then to a left-input-adapter node 115. Connected to the left-input-adapter node 115 is a join node 130, which is an example of a beta node.

A beta node has two inputs, unlike one-input nodes, such as object-type nodes and alpha nodes. A beta node can receive tuples in its left-input and data objects, or simply referred to as objects, in its right-input. Join node, not node, and exist node are some examples of beta nodes. All nodes may have one or more memories to store a reference to the data objects and tuples propagated to them, if any. The left-input-adapter node creates a tuple with a single data object and propagates the tuple created to the left-input of the first beta node connected to the left-input-adapter node, where the tuple is placed in the left-input memory of the beta node and then join attempts are made with all the objects in the right memory of the beta node. For example, the left-input-adapter node 115 creates a tuple 103 from the data object 101 and propagates the tuple to the join node 130. When the tuple 103 propagates into the join node 130, the tuple 103 is placed in the left memory of the join node.

When another data object 104 enters the right-input of the join node, the data object 104 is placed in the right memory of the join node 130 and join attempts are made with all the tuples (including tuple 103) in the left memory of the join node 130. The tuples placed in the left memory of the join node 130 are partially matched. If a join attempt is successful, the data object 104 is added to the tuple 103 and is then propagated to the left-input of the next node in the network 100. Such evaluation and propagation continue other nodes down the network 100, if any, until the tuple 103 reaches the terminal node 140. When the tuple 103 reaches the terminal node 140, the tuple 103 is fully matched. At the terminal node 140, an activation is created from the fully matched tuple and the corresponding rule. The activation is placed onto an agenda of the rule engine for potential firing or potential execution.

As the number of data objects increases, it takes longer to match a new data object propagating into the beta node (e.g., the join node 130 in FIG. 1) with other already asserted data objects in the memory of the beta node. This is because the rule engine has to try matching the new data object with each existing data object in the beta node memory using the given constraints. As a result, the efficiency of the rule engine drops significantly as the number of data objects increases. This becomes a serious limitation for systems where thousands of data objects are asserted and the network includes multiple beta nodes.

### BRIEF DESCRIPTION OF THE DRAWINGS

The present invention is illustrated by way of example, and not by way of limitation, in the figures of the accompanying drawings and in which:

FIG. 1 illustrates a conventional Rete network.

FIG. 2A illustrates one embodiment of a process to evaluate rules using a rule engine with beta node indexing.

FIG. 2B illustrates one embodiment of a process to index a new element propagating into a beta node of a network created by a rule engine.

FIG. 3A shows one embodiment of an indexed beta node.

FIG. 3B shows conceptual diagrams of some embodiments of an indexed beta node memory.

FIG. 4 shows one embodiment of a rule engine usable with some embodiments of the present invention.

FIG. 5 shows one embodiment of a system usable with some embodiments of the present invention.

FIG. 6 shows an alternate embodiment of a system usable with some embodiments of the present invention.

FIG. 7 illustrates a block diagram of an exemplary computer system.

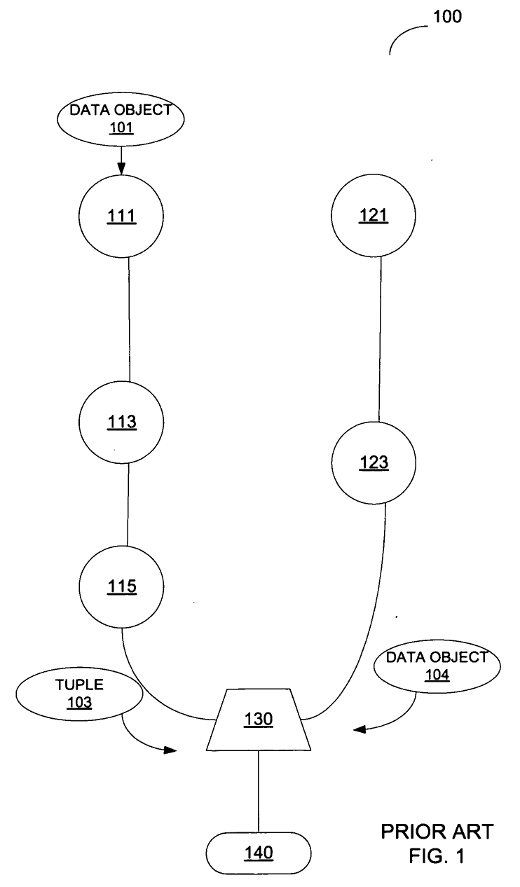

### DETAILED DESCRIPTION

Described herein are some embodiments of beta node indexing in a rule engine. In one embodiment, a rule engine creates a network based on a set of rules. The network includes at least one multiple-input node, such as a beta node having two inputs. The beta node further includes a memory associated with each input. The rule engine may generate a single index for at least one of the memories of the beta node based on a set of predetermined attributes of elements within the memory. Examples of the elements include tuples in a left memory of the beta node and data objects in a right memory of the beta node. The index includes a set of composite keys, each having a value of each of the attributes. More details of some embodiments of the rule engine are described below.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required operations. The required structure for a variety of these systems will appear from the description below. In addition, the present invention is not described with reference to any particular programming language. It will be appreciated that a variety of programming languages may be used to implement the teachings of the invention as described herein.

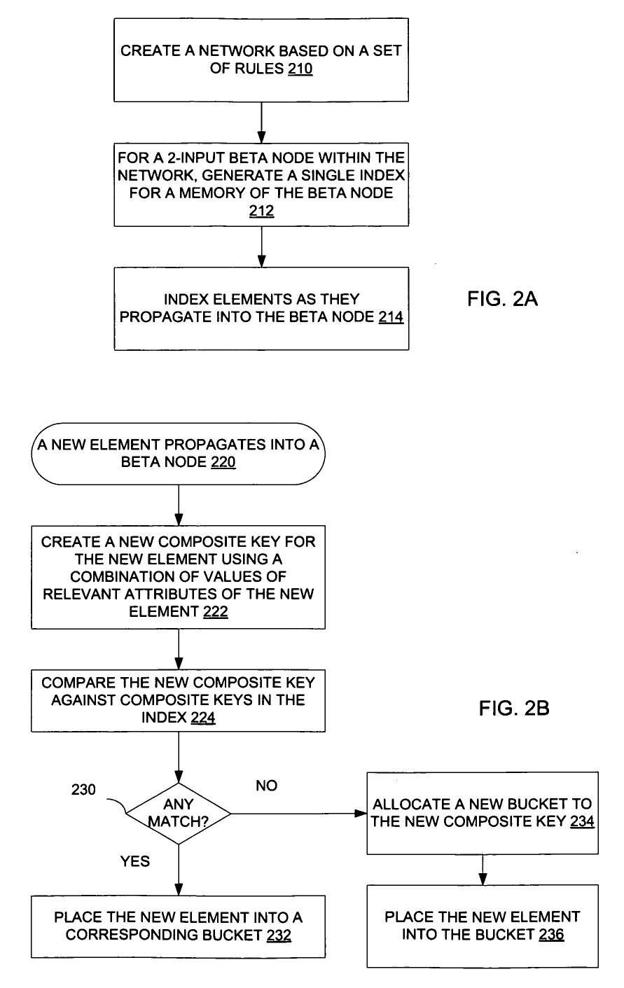

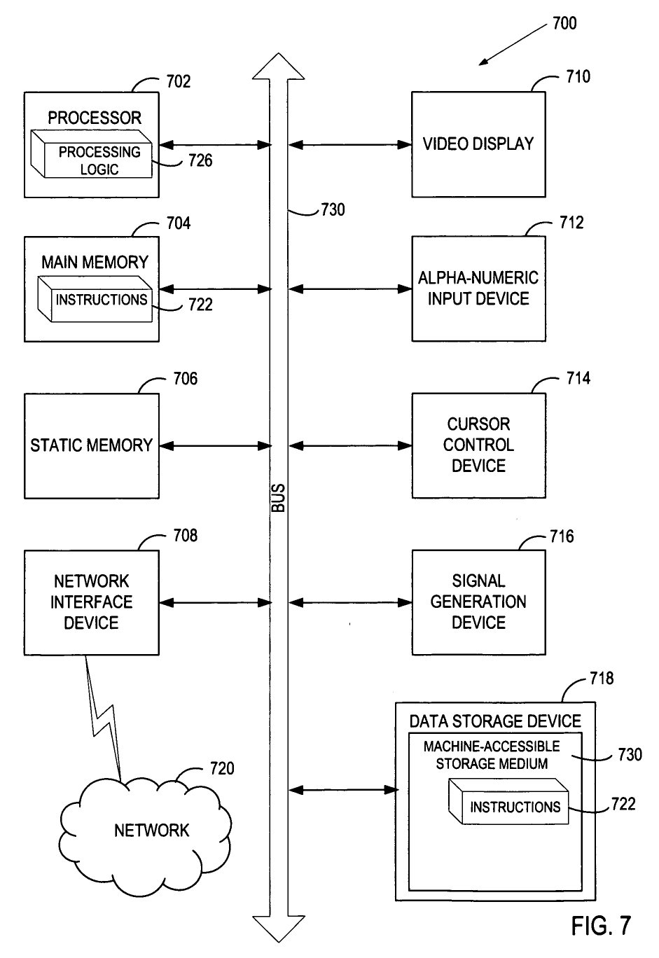

FIG. 2A illustrates one embodiment of a process to evaluate rules using a rule engine with beta node indexing. The process may be performed by processing logic that may comprise hardware (e.g., circuitry, dedicated logic, programmable logic, microcode, etc.), software (such as instructions run on a processing device), firmware, or a combination thereof. For example, the computer system 700 in FIG. 7 may perform at least part of the process in some embodiments.

Referring to FIG. 2A, processing logic creates a network based on a set of rules (processing block 210). The set of rules may be provided by a user of a rule engine. For example, in a business application, the set of rules includes business rules pertaining to business transactions. In some embodiments, the network includes a number of nodes. Some of the nodes are multiple-input nodes, such as a beta node having two inputs. Further, each multiple-input node has a memory associated with each distinct input. For example, a beta node has a left memory associated with its left input and a right memory associated with its right input.

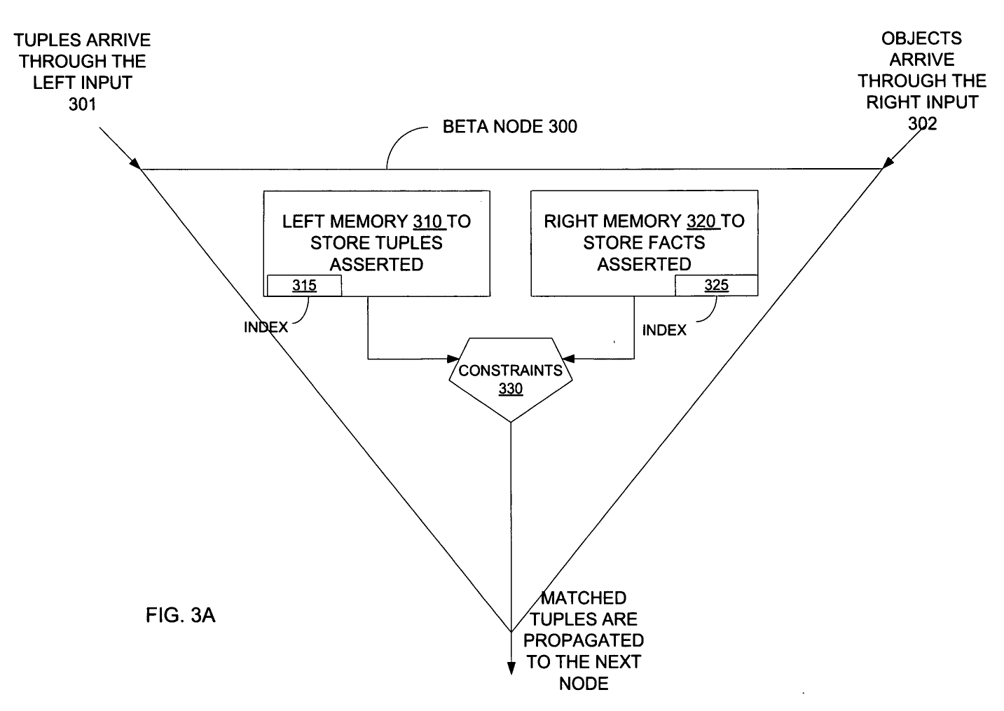

FIG. 3A illustrates one embodiment of a beta node. The beta node 300 has a left input 301 and a right input 302. The beta node 300 further includes a left memory 310 associated with the left input 301 and a right memory 320 associated with the right input 302. Elements may propagate into the beta node 300 through its inputs 301 and 302. For example, tuples may propagate into the beta node 300 through its left input 301 and be stored in the left memory 310, while fact objects may propagate into the beta node 300 via its right input 302 and be stored in the right memory 320.

Referring back to FIG. 2A, processing logic generates a single index for at least one memory of the multiple-input node in some embodiments (processing block 212). For example, processing logic may index the right memory of the beta node, the left memory of the beta node, or both left and right memories of the beta node. The index may be computed by a hash function. Further, the index is organized by composite keys that are associated with some predetermined attributes of the elements in the corresponding memory. These attributes may also be referred to as attributes of interest. For instance, the rule engine may be used in a health management organization to track which patients need a certain preventive checkup, such as a mamogram. Specifically, the rule in this example may be: female patients between 40 and 50 years old should get a reminder to obtain a mamogram every two years. Then the attributes of interest of the data objects in the right memory of the beta node may be gender and age group. Processing logic may index the patients by a composite key having a first value indicative of the gender of the patients and a second value indicative of the age group of the patients. In the current example, patients having a composite key of [Female, 40-50] get a reminder to obtain a mamogram every two years.

Referring back to FIG. 3A, each of the left memory 310 and the right memory 320 are indexed. In some embodiments, the left memory index 315 is stored inside the left memory 310 and the right memory index 325 is stored inside the right memory 320.

In some embodiments, processing logic allocates a bucket in the indexed beta node memory for each unique composite key while creating the index. Processing logic may place elements having the unique composite key into the bucket. In other words, each bucket is associated with a unique composite key. A bucket as used herein generally refers to a logical storage area or section within a memory of a node to store elements. More details on the buckets associated with unique composite keys are discussed below with reference to FIG. 3B.

Referring back to FIG. 2A, processing logic indexes the element using the single index when a new element propagates into the multiple-input node (processing block 214). Because the index is organized by composite keys associated with the attributes of interest, processing logic evaluates the new element against the relevant rule(s) as processing logic indexes the new element. More details of some embodiments of beta node indexing and rule evaluation are described below.

Note that in some embodiments, beta node indexing in the rule engine may be enabled and/or disabled as needed and/or desired by an administrator of the rule engine. Some examples of the factors that the administrator may consider in deciding whether to enable or disable beta node indexing include the available computing resources, the type of rules, the number of elements to be processed, etc.

FIG. 2B illustrates one embodiment of a process to index a new element propagating into a beta node of a network created by a rule engine. The process may be performed by processing logic that may comprise hardware (e.g., circuitry, dedicated logic, programmable logic, microcode, etc.), software (such as instructions run on a processing device), firmware, or a combination thereof. For example, the computer system 700 in FIG. 7 may perform at least part of the process in some embodiments.

The process begins when a new element propagates into a beta node within a network created by a rule engine (processing block 220). Processing logic creates a new composite key for the new element using a combination of values of the relevant attributes of the new element (processing block 222). The relevant attributes may also be referred to as the attributes of interest. Some examples of the element include a tuple (for a left memory in a beta node) and a data object (for a right memory in a beta node). Referring to the above example, the attributes of interest are gender and age groups. Suppose the new element is a data object representing a patient named Jane Smith. Jane Smith is a female patient of age 45. When the data object propagates into the beta node, processing logic may create a composite key of [Female, 40-50] for Jane Smith. In another scenario, suppose a second data object representing a patient named John Smith propagates into the beta node, where John Smith is a male patient of age 45. Then processing logic may create a composite key of [Male, 40-50] for John Smith.

After creating the new composite key for the element, processing logic compares the new composite key against existing composite keys in the index of the beta node memory (processing block 224). Referring to the above example, the existing composite keys in the index may include [Male, 18-35], [Male, 36-50], [Female, 18-39], [Female, 40-50], [Female, 51-60], etc. Processing logic then determines if there is any existing composite key matching the new composite key (processing block 230). If there is a matching composite key in the index, processing logic places the new element into a corresponding bucket (processing block 232). Referring back to the above example, if the composite key of [Female, 40-50] already exists in the index, then the data object representing Jane Smith (which has a composite key of [Female, 40-50]) is placed into a bucket corresponding to [Female, 40-50].

However, if processing logic determines that there is no matching composite key in the index, then processing logic allocates a new bucket to the new composite key (processing block 234) and places the new element into the new bucket (processing block 236). Referring back to the above example, if the composite key of [Female, 40-50] does not exist in the index, then processing logic may allocate a new bucket to the composite key of [Female, 40-50] and place the data object representing Jane Smith into the new bucket.

One should appreciate that indexing the beta node memory significantly improves performance of rule evaluation. Referring to FIG. 3A, constraints 330 are applied to elements from the indexed left and right memories 310 and 320. Because the elements have already been categorized or grouped by their respective composite keys, which are associated with values of the attributes of interest, processing logic may readily identify or select elements that result in a match under the constraints 330. For example, when the data object representing Jane Smith is placed into the bucket associated with [Female, 40-50], processing logic also determines that the data object representing Jane Smith matches the relevant rule (i.e., female patients between 40 and 50 years old should get a reminder to obtain a mamogram every two years). As such, elements inside the bucket associated with [Female, 40-50] result in matched tuples, which may further propagate from the beta node to the next node. As discussed above, when a matched tuple eventually reaches a terminal node, the matched rule may be placed in an agenda of the rule engine for potential firing or execution. On the other hand, elements inside other buckets do not match the relevant rule, and thus, no matched tuples are resulted to be propagated to the next node.

The above technique may provide further optimization in processing rules when a rule engine attempts to find matches between elements. The example shown in FIG. 3B illustrates this advantage.

FIG. 3B shows conceptual diagrams of some embodiments of an indexed beta node memory. In the current example, the rule engine is attempting to identify persons having the same set of parents. As such, the composite key includes a first value of the attribute for father (F) and a second value of the attribute for mother (M), i.e., the composite key is of the form [F, M]. A bucket is allocated for each unique composite key. In other words, a bucket is allocated for each unique pair of father and mother. For example, in beta node memory 360A on top of FIG. 3B, a bucket 361A is allocated to [F1, M1], a bucket 363A is allocated to [F1, M2], a bucket 365A is allocated to [F3, M3], a bucket 367A is allocated to [Fi, Mj], etc. The elements in the current example are data objects representing different persons. For instance, a person C1 is the child of F1 and M1, and thus, C1 is placed in the bucket 361A. Likewise, a person C4 is the child of F1 and M1, and thus, C4 is placed in the bucket 361A. A person C2 is the child of F1 and M2, and thus, C2 is placed in the bucket 363A. A person C3 is the child of F3 and M3, and thus, C3 is placed in the bucket 365A. A person Ck is the child of Fi and Mj, and thus, Ck is placed in the bucket 367A.

When a new element, a data object representing a person Cm, propagates into the beta node memory 360A, processing logic determines that the father and mother of Cm are F3 and M3, respectively. Therefore, processing logic generates a composite key of [F3, M3] for Cm. Further, processing logic finds a match for Cm among the composite keys associated with the existing buckets, i.e., the composite key of bucket 365A. Thus, processing logic places Cm into the bucket 365A. The resultant beta node memory 360B is shown in the middle of FIG. 3B, where the bucket 365B now has two data objects, namely, C3 and Cm.

When another new element, a data object representing a person Cn, propagates into the beta node memory 360B, processing logic determines that the father and mother of Cn are F2 and M2, respectively. Therefore, processing logic generates a composite key of [F2, M2] for Cn. Further, processing logic tries to find a match for Cn among the composite keys associated with the existing buckets. Although the composite key of bucket 363B partially matches [F2, M2], processing logic does not place Cn into the bucket 363B because the composite key [F1, M2] of the bucket 363B is not an exact match of [F2, M2]. Because none of the composite keys of the existing buckets matches [F2, M2], processing logic allocates a new bucket 369C to [F2, M2] and places Cn into the new bucket 369C as shown in the third beta node memory 360C on the bottom of FIG. 3B.

Using the above technique, processing logic does not have to compare a new element propagating into the beta node memory 360A with each of the existing data objects in the beta node memory 360A (i.e., each of the data objects previously asserted into the beta node memory 360A). In other words, processing logic does not have to iterate over all existing elements in the beta node memory 360A each time a new element arrives in order to find existing elements matching the new element, if any. Rather, the new element is implicitly matched to other elements (if any) inside a bucket when the new element is placed into the bucket. One should appreciate that the efficiency of the above approach increases significantly as the number of elements increases.

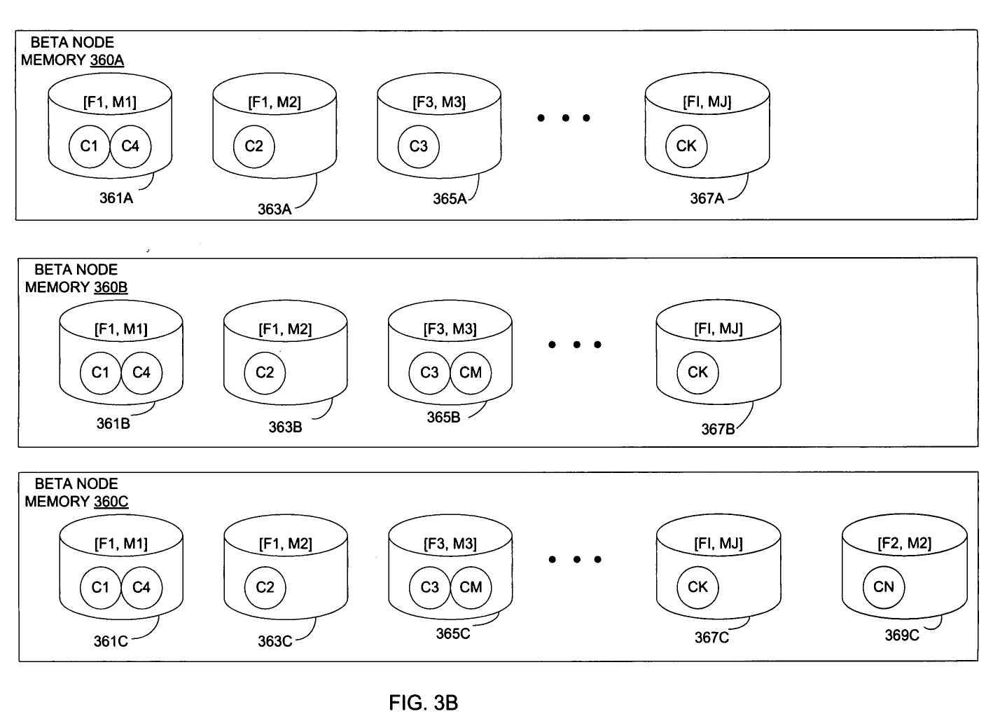

FIG. 4 shows one embodiment of a rule engine usable to index beta nodes. In some embodiments, a rule engine 430 is operatively coupled to a rule repository 410 and a working memory 420. The rule repository 410 stores a rule set having a number of rules. The rule repository 410 may also be referred to as a production memory. The working memory 420 stores data objects (also referred to as facts) that have been asserted.

In some embodiments, the rule engine 430 includes a pattern matcher 432 and an agenda 434. The pattern matcher 432 generates network (such as a Rete network) to evaluate the rules from the rule repository 410 against the data objects from the working memory 420. One or more of the nodes within the network are multiple-input nodes, such as a beta node. A beta node indexing module 436 within the pattern matcher 432 creates a single index for at least one memory within the beta node. The beta node indexing module 436 may examine the relevant rules from the rule repository 410 to determine which attributes are of interest. Then the beta node indexing module 436 may index the memory by the attributes of interest. Details of some examples of beta node indexing have been described above. By indexing the beta node memory, the pattern matcher 432 may evaluate the rules more efficiently as the number of data objects increases.

As the data objects propagating through the network, the pattern matcher 432 evaluates the data objects against the rules. Fully matched rules result in activations, which are placed into the agenda 434. The rule engine 430 may iterate through the agenda 434 to execute or fire the activations sequentially. Alternatively, the rule engine 430 may execute or fire the activations in the agenda 434 randomly.

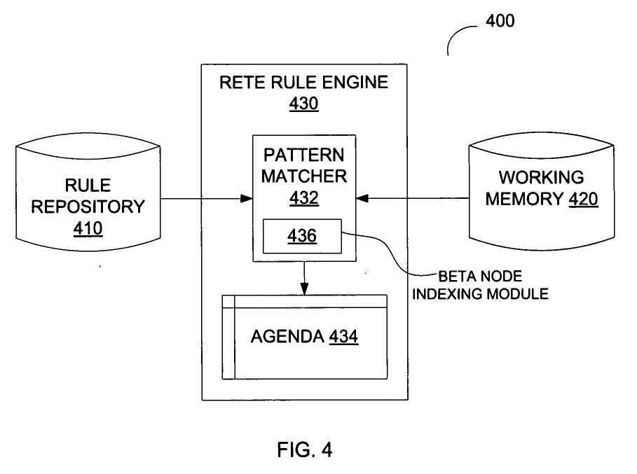

FIG. 5 illustrates one embodiment of a system usable with some embodiments of the present invention. The system 7100 includes a client machine 7110 and a server 7120, which are coupled to each other via a network 7130. The client machine 7110 may include a computing machine, such as a desktop personal computer (PC), a laptop PC, a personal digital assistant (PDA), a mobile telephone, etc. The network 7130 coupling the client machine 7110 to the server 7120 may include various kinds of networks, such as an intranet, the Internet, etc. The server 7120 may be implemented using the computer system 700 as illustrated in FIG. 7.

In some embodiments, the server 7120 includes a rule engine 7123 having an architecture as illustrated in FIG. 4. The client machine 7110 may present a GUI 7112 (e.g., a web-page rendered by a browser) to allow users to input rule sets and/or data objects, which may be sent to the server 7120 to be processed using the rule engine 7123 as discussed above.

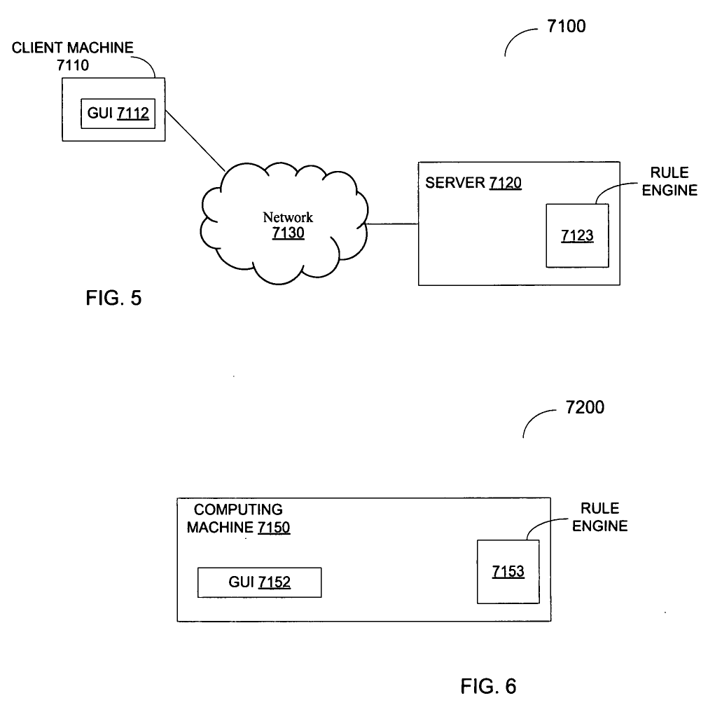

FIG. 6 illustrates an alternate embodiment of a system usable with some embodiments of the present invention. The system 7200 includes a computing machine 7150, which may be implemented using the computer system 700 illustrated in FIG. 7. The computing machine 7150 includes a rule engine 7153 and a GUI 7152. In some embodiments, users may input files for rules using the GUI 7152. Then the files may be processed by rule engine 7153 as discussed above.

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a LAN, an intranet, an extranet, and/or the Internet. The machine may operate in the capacity of a server or a client machine in client-server network environment, or as a peer machine in a peer-to-peer (or distributed) network environment. The machine may be a personal computer (PC), a laptop PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-accessible storage medium 730 (also known as a computer-readable storage medium) on which is stored one or more sets of instructions (e.g., software 722) embodying any one or more of the methodologies or functions described herein. The software 722 may also reside, completely or at least partially, within the main memory 704 and/or within the processing device 702 during execution thereof by the computer system 700, the main memory 704 and the processing device 702 also constituting machine-accessible storage media. The software 722 may further be transmitted or received over a network 720 via the network interface device 708.

While the machine-accessible storage medium 730 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, optical and magnetic media, etc.

Thus, some embodiments of beta node indexing in a rule engine have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
creating a network based on a set of one or more rules, the network comprising at least one multiple-input node, the at least one multiple-input node comprising a plurality of memories, each of the plurality of memories associated with a distinct input of the at least one multiple-input node; and
generating a single index for at least one of the plurality of memories of the at least one multiple-input node of the network based on a plurality of attributes of elements within the at least one memory, the single index comprising a plurality of composite keys, each of the plurality of composite keys comprising a value of each of the plurality of attributes.

2. The method of claim 1, further comprising:
propagating a new element into the at least one multiple-input node; and
determining which of the elements within the at least one of the plurality of memories matches the new element based on the single index without iterating over each of the elements within the at least one of the plurality of memories.

3. The method of claim 1, wherein generating a single index for the at least one of the plurality of memories of the at least one multiple-input node based on the plurality of attributes of the elements within the at least one of the plurality of memories comprises:
creating each of the composite keys using a unique combination of the value of each of the plurality of attributes; and
allocating a bucket to each of the composite keys.

4. The method of claim 1, further comprising:
generating a composite key for a new element propagated into the at least one multiple-input node;
if the composite key matches one of the plurality of composite keys, placing the new element into a bucket associated with the one of the plurality of composite keys; and
if none of the plurality of composite keys matches the new composite key, allocating a new bucket to the new composite key and placing the new element into the new bucket.

5. The method of claim 1, wherein the set of one or more rules comprises one or more business rules.

6. The method of claim 1, wherein the network comprises a Rete network.

7. The method of claim 1, wherein the at least one multiple-input node is a beta node.

8. An apparatus comprising:
a rule repository to store a set of one or more rules; and
a rule engine core coupled to the rule repository to create a network based on the set of one or more rules, the network comprising at least one multiple-input node, the at least one multiple-input node comprising a plurality of memories, each of the plurality of memories associated with a distinct input of the at least one multiple-input node, and to generate a single index for at least one of the plurality of memories of the at least one multiple-input node based on a plurality of attributes of elements within the at least one of the plurality of memories, the single index comprising a plurality of composite keys, each of the plurality of composite keys comprising a value of each of the plurality of attributes.

9. The apparatus of claim 8, further comprising:
a working memory coupled to the rule engine core, to store a fact, which is introduced into the network as a new element when asserted, wherein the new element propagates into the at least one multiple-input node to cause the rule engine core to determine which of the elements within the at least one of the plurality of memories matches the new element based on the single index without iterating over each of the elements within the at least one of the plurality of memories.

10. The apparatus of claim 8, wherein the rule engine core creates each of the composite keys using a unique combination of the value of each of the plurality of attributes and allocates a bucket to each of the composite keys.

11. The apparatus of claim 8, wherein the rule engine core generates a composite key for a new element propagated into the at least one multiple-input node, the rule engine core places the new element into a bucket associated with the one of the plurality of composite keys if the composite key matches one of the plurality of composite keys, and the rule engine core allocates a new bucket to the new composite key and places the new element into the new bucket if none of the plurality of composite keys matches the new composite key.

12. The apparatus of claim 8, wherein the network comprises a Rete network.

13. The apparatus of claim 8, wherein the at least one multiple-input node is a beta node.

14. A system comprising the apparatus of claim 8, further comprising:
a user interface operatively coupled to the rule repository to receive the set of one or more rules from a user, wherein the plurality of rules comprises a plurality of business rules for determining if an applicant qualifies for a mortgage.

15. A system comprising the apparatus of claim 8, further comprising:
a server operable to execute the core rule engine; and
a client machine communicatively coupled to the server via a network, the client machine comprising a user interface to receive the plurality of rules from a user and to send the plurality of rules to the server via the network.

16. A computer-readable medium that provides instructions that, when executed by a processor, will cause the processor to perform operations comprising:
creating a network based on a set of one or more rules, the network comprising at least one multiple-input node, the at least one multiple-input node comprising a plurality of memories, each of the plurality of memories associated with a distinct input of the at least one multiple-input node; and
generating a single index for at least one of the plurality of memories of the at least one multiple-input node of the network based on a plurality of attributes of elements within the at least one memory, the single index comprising a plurality of composite keys, each of the plurality of composite keys comprising a value of each of the plurality of attributes.

17. The computer-readable medium of claim 16, further comprising:
propagating a new element into the at least one multiple-input node; and
determining which of the elements within the at least one of the plurality of memories matches the new element based on the single index without iterating over each of the elements within the at least one of the plurality of memories.

18. The computer-readable medium of claim 16, wherein generating a single index for the at least one of the plurality of memories of the at least one multiple-input node based on the plurality of attributes of the elements within the at least one of the plurality of memories comprises:
creating each of the composite keys using a unique combination of the value of each of the plurality of attributes; and
allocating a bucket to each of the composite keys.

19. The computer-readable medium of claim 16, further comprising:
generating a composite key for a new element propagated into the at least one multiple-input node;
if the composite key matches one of the plurality of composite keys, placing the new element into a bucket associated with the one of the plurality of composite keys; and
if none of the plurality of composite keys matches the new composite key, allocating a new bucket to the new composite key and placing the new element into the new bucket.

20. The computer-readable medium of claim 16, wherein the set of one or more rules comprises one or more business rules.

21. The computer-readable medium of claim 16, wherein the network comprises a Rete network.

22. The computer-readable medium of claim 16, wherein the at least one multiple-input node is a beta node.
